(19) United States
(12) Patent Application Publication
(10) Pub. No.: US 2010/0101298 A1
(43) Pub. Date: Apr. 29, 2010

(54) Dynamic Centering Fixture with Hydraulic Load Delivery Compensation

(76) Inventor: Peter T. Carstensen, Adirondack, NY (US)

Correspondence Address: FROMMER LAWRENCE & HAUG LLP, 745 FIFTH AVENUE, NEW YORK, NY, 10151, US

(21) Appl. No.: 12/260,299

(22) Filed: Oct. 29, 2008

(51) Int. Cl. B21D 28/04; B23Q 3/10; B23Q 7/06; B21D 28/36; B23Q 7/00

(52) U.S. Cl. 72/420; 269/71

(57) ABSTRACT

A dynamic centering apparatus, suitable for centering a workpiece on a work surface, comprising a plurality of hydraulic actuators coupled to individual cells of a hydraulic pump.

### FIELD OF THE INVENTION

The present invention relates, in general, to workpiece centering for industrial processing. More particularly, the present invention provides an apparatus and a method for positioning a workpiece. Even more particularly, the present invention provides an apparatus and a method for centering a cylindrical metal ingot for central piercing in a punch press.

### BACKGROUND OF THE INVENTION

In many industrial applications it is necessary to handle workpieces that are unwieldy because of their weight, size, material, temperature, or other physical characteristics, for placement or fixturing the workpiece. The more difficult a workpiece is to handle because of any physical aspect of the workpiece, the more difficult precise placement of the workpiece becomes. In situations in which the workpiece cannot be handled by humans because of the physical characteristics of the workpiece, or because of the environment in which the work must be performed, or both, material handling equipment is often used for placement. Accurate workpiece placement under such conditions is not easily achieved but is desirable because it often results in reduced processing time and labor required to properly finish the end product.

The forging ring rolling process, for example, is an industrial process that can benefit from accurate workpiece positioning. In the ring rolling process, an original ingot of metal in a plastic state, must be handled. The ingot is usually quite heavy, hot, and of various shapes, but must be formed into a generally cylindrical piece. Once formed into a cylinder, the ingot is pierced with a punch to form a hole in the center. The annular part is further processed in a metal forming machine, such as a ring roller, to roll the ring into a specific configuration. The more centrally located the initial punch is in the cylinder, the more desirable the physical characteristics are in the final product. In particular, a centrally located punch leads to uniform wall thicknesses in the finished ring.

Generally, positioning of the original workpiece in industrial applications can be accomplished by employing a manually operated manipulator, resembling a fork truck, to position the piece. More precise positioning, such as centering, is achieved by manipulating the workpiece with manual tools, such as crow bars. Alternately, automated methods of accurate positioning exist in which ball screw linear actuators are equipped with electronic position feedback transducers. Positional information from the transducers is processed by a logic center, such as a programmable logic controller (PLC) and adjustments can be made during the centering process.

The manual positioning method described above, when used in forging processes, requires close human proximity to the heavy and hot, up to 2500° F., workpieces, creating the risk of personal injury. Additionally, as the workpieces are manually moved, they exhibit non-continuous stick-slip coefficients as they are moved into position. This increases the difficulty in precise manual positioning of the workpiece. Further still, the manual methods rely on only visual center referencing. All of these factors decrease the precision, repeatability, and speed of the process. Reduced precision and repeatability lead to poor final quality and an increased rejection rate.

The automated methods described above address the precision issue by offering superior alignment over the manual methods. However, hydraulic cylinders and mechanical ball screws are not generally suitable for high temperature working environments. As mentioned above, the workpieces are at high temperature, approximately 2500° F., creating a working environment not suitable for such devices. When use at elevated temperature, high failure rates of component parts are common, leading to poor quality, high production down time, and high rejection rates.

### SUMMARY OF THE INVENTION

It is seen from the foregoing that there is a need for an apparatus and method for accurately and reliably locating a workpiece that is difficult to position manually. There is also a need for a hydraulic apparatus to position a workpiece in a harsh environment.

Disclosed is a centering apparatus for positioning a workpiece in which a plurality of hydraulic actuators are each individually connected to a cell of a positive displacement hydraulic pump, the pump driven by a motor controlled by a drive system.

Also described is a centering apparatus for positioning a workpiece using a plurality of hydraulic actuators, each actuator comprising a rod end, an annulus end, and an actuator rod with a free end, the rod configured for linear movement in a first direction at least partially into the actuator and in a second direction, in which the actuator rod is at least partially extended from the actuator.

Also disclosed is a centering apparatus for positioning a workpiece in which a plurality of hydraulic actuators have associated actuator rods, the rods having rollers mounted at the free end for rotation.

One embodiment describes a centering apparatus for positioning a workpiece in which a plurality of hydraulic centering actuators, such as double acting hydraulic cylinders, are configured to accept hydraulic supply lines at the annulus end and the rod end.

In yet another embodiment, a centering apparatus for positioning a workpiece in which a plurality of hydraulic centering actuators are connected to individual cells or pistons of a multi-piston hydraulic piston pump, the pump driven by a servo motor, a poly-phase induction motor, or a synchronous motor is described. A shaft encoder may be included according to one embodiment. The encoder may be provided to communicate with the drive system. The drive system may comprise closed loop controls or pump modeling capabilities.

Also described is a centering apparatus for positioning a workpiece in which a plurality of hydraulic centering actuators are supported in rotation with respect to a process table by positioning actuators. In an embodiment described, the positioning actuators are adapted to fixedly support the centering actuators against rotation in at least one position. The positioning actuators may be connected to the hydraulic pump as described.

Also describe is a method for centering a workpiece on a process table. As disclosed, the method includes a centering apparatus comprising a plurality of actuators with actuator rods, configured for linear movement at least partially into and out from the actuator, a multi-cell positive displacement hydraulic pump coupled to a motor with each cell individually connected to an actuator. In one embodiment, the motor is controlled by a drive system. The method steps may include securing the actuators proximate to the workpiece, and commanding the drive unit to rotate the hydraulic pump at a rotational speed to produce a first and second specified flow. The first flow may initialize the position of the actuators and the second specified flow may advance the actuator rods until the workpiece is centered, and a predetermined pump output pressure is achieved, at which time a signal is sent to the drive unit signaling the drive to stop driving the pump because the workpiece is properly positioned.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic of the instantly claimed centering device.

### DETAILED DESCRIPTION OF PREFERRED EMBODIMENTS

The invention will now be described more fully hereinafter with reference to the accompanying drawings, in which exemplary embodiments of the invention are shown. This invention may, however, be embodied in many different forms and should not be construed as limited to the illustrated embodiments set forth herein. Rather, these illustrated embodiments are provided so that this disclosure will be thorough and complete, and will convey the scope of the invention to those skilled in the art.

In the disclosure, the claimed centering device is described with regard to use in a forging process. This is for convenience only. As one of ordinary skill in the art will appreciate, the disclosed centering apparatus has utility in many industrial applications, not limited to forging. The disclosed apparatus is useful in industrial applications in which the workpiece cannot be easily positioned manually, or manual positioning does not yield satisfactory results, or in which the working environment presents difficulty or danger to operators.

The instantly claimed apparatus relates to a device for positioning a workpiece on a work surface or process table. The surface is generally a flat, horizontal surface, although non-horizontal and non-flat applications are anticipated.

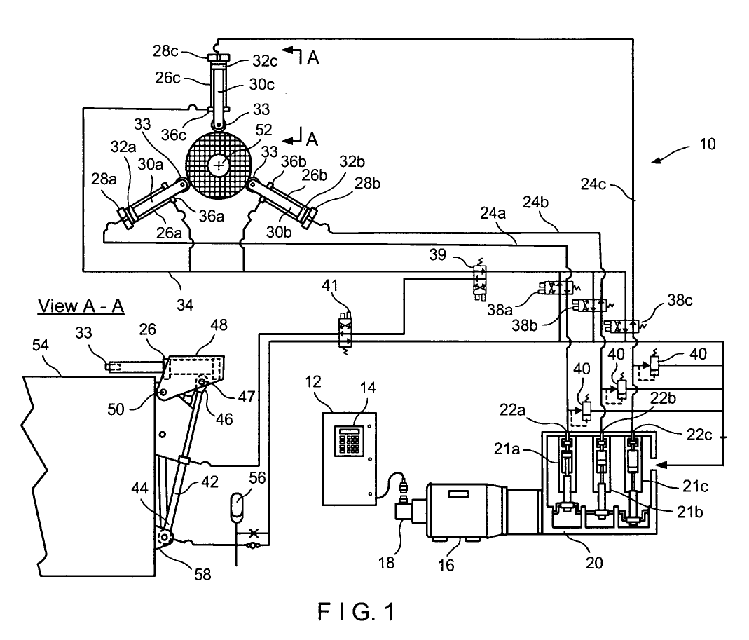

As depicted in FIG. 1, one embodiment of the instant centering apparatus 10 comprises a drive system 12 linked to a motor 16, the motor 16 coupled to a positive displacement hydraulic pump 20. The drive system 12 may have an interface 14 for user input of data. The pump 20 has multiple cells or pistons 21a, 21b, and 21c with individual pump cell outlets 22a, 22b, and 22c to which a first end of individual first hydraulic supply lines 24a, 24b, and 24c are attached. A second end of the individual first hydraulic supply lines is attached to hydraulic centering actuators 26a, 26b, and 26c (collectively 26) at the annulus end 28a, 28b and 28c of the centering actuators, respectively. In the exemplary drawing provided, three centering actuators are shown for clarity. It is anticipated that more or fewer actuators may be used as appropriate for various applications.

Centering actuators 26 are preferably dual acting hydraulic cylinders. Dual acting cylinders are capably of applying both a push and a pull force through the constituent actuator rod, illustrated here as element 30a, 30b and 30c (collectively 30). In order to apply push and pull force, dual acting cylinders require pressurized hydraulic fluid to be alternatingly applied to opposing sides of a piston 32a, 32b, and 32c (collectively 32) fixed to one end of actuator rod 30, located within the body of the actuator 26. The second end of actuator rod 30 is configured to engage the workpiece 1. In one embodiment, the second end of actuator rod 30 is fitted with a roller 33 to minimize lateral reactionary forces generating when centering a workpiece 1. In further embodiments, roller 33 may have an axis of rotation generally parallel or perpendicular to the axis of the workpiece 1. In a further embodiment, the second end of the actuator rod 30 of the centering actuator 26 may comprise a spherical roller supported for free rotation with respect to the actuator rod 30 axis.

As illustrated, a first end of second hydraulic supply line 34 is commonly attached to the rod ends 36a, 36b, and 36c of actuators 26, respectively, as in a manifold arrangement. The second end of second hydraulic supply line 34 is placed in fluid communication with the pump cells 21 through flow control valves 38 when the flow control valve solenoids (not shown) are energized. In a de-energized state, flow control valves 38 divert fluid flow in second hydraulic supply line 34 to return hydraulic fluid to the pump 20. Alternatively, single acting actuators may be used in which case, second hydraulic supply line 34 is not needed.

Over-pressure protection devices 40 and two position-four way directional flow control valves 38 may be provided along the first and second hydraulic supply lines 24 and 34, with additional hydraulic components, as would be recognized as necessary to one skilled in the art, to regulate and direct hydraulic fluid flow.

The pump 20 is operated by motor 16 in response to control signals provided by the drive system 12 to provide appropriate hydraulic fluid pressure and flow. In one embodiment, the drive system 12 is an electronic motor drive with pump modeling capabilities with a user interface 14. Similar drive systems are described in U.S. Pat. Nos. 6,494,685, 6,652,685, and 5,971,721 assigned to KADANT Inc. and marketed under the trademark UNiGY®. The cited documents are hereby incorporated by reference. Additional drive systems may be described in pending applications or publications by KADANT Inc. The drive system 12 is linked to a motor 16 which may be a servo-motor, a poly-phase induction motor, or a synchronous motor. The motor may be equipped with a shaft encoder 18 in communication with the drive system 12.

User interface 14 allows entering of commands for the drive system 12 to provide power to the motor 16 calculated to provide the appropriate hydraulic flow characteristics. Power to be supplied to the motor 16 is calculated based on dynamic operational loads that are analyzed and compensated for in real time using pump modeling algorithms in the drive system 12.

In one embodiment of the instant centering apparatus, a plurality of centering actuators 26 are arranged equidistant from a geometric center point 52. As illustrated with three centering actuators 26, the actuators are arranged in a radial fashion, spaced 120° apart from each other. Other configurations are possible with fewer or additional actuators. For example, with four actuators, each actuator would be placed 90° apart from the adjacent actuators.

One embodiment of the claimed centering apparatus 10 includes a positioning or jacking actuator 42 linked to positioning actuator 26. View A-A as provided in FIG. 1 illustrates one jacking actuator 42 arranged with one positioning actuator 26. It is anticipated that jacking actuators 42 may be used with one or more of the positioning actuators 26 as may be convenient to move the centering actuators into or out of position to engage the workpiece 1.

Jacking actuator 42 is pivotally supported at its annulus end 44 by an appropriate support 58. Jacking actuator rod end 46 is connected to support linkage 48 at attachment point 47. Positioning actuator 26 is fixed to support linkage 48 and supported for rotational displacement by support linkage 48 through pivot point 50. Attachment point 47 and pivot point 50 may be separated by a distance. As illustrated in section A-A of FIG. 1, positioning actuator rod 46 is in an extended position from actuator 42.

In the position illustrated, centering actuator 26 is generally parallel to process table work surface 54. This is achieved by providing pressurized hydraulic fluid to the annulus end 44 of positioning actuator 42 which bears against one side of positioning actuator piston (not shown) forcing the positioning actuator rod end 46 to extend from the positioning actuator 42. Extending positioning rod end 46 exerts a force on attachment point 47, urging support link 48 to rotate in a counterclockwise direction in view A-A of FIG. 1. At a particular point in the extension of positioning actuator 42, support linkage 48 is rotated sufficiently to place centering actuator 26 in proper position for centering, for example, parallel to the work surface 54. At the proper position, there may be a mechanical stop (not shown) configured to prevent further rotation of the support linkage 48. Sufficient hydraulic pressure may be maintained in positioning actuator 42 to prevent unintended counter rotation of the support linkage 48 during centering. In one embodiment, sufficient hydraulic pressure may be stored in accumulator 56 to support positioning actuator 42 against rotation about pivot point 50.

Incremental compensation routines are processed in the electronic drive system 12 so as to affect uniform output of each pump cell 22 as load variations occur. Load variations can occur in the described process as the workpiece 1 demonstrates non-continuous stick-slip coefficients of friction as the workpiece 1 is moved on the work surface 54. Developing a “look up” table or formula that will allow incorporation of the learned or known pump fluid output variations that develop as the centering actuator rods 30 move linearly will allow utilization of these known or learned compensations to be applied to the output of the electronic drive system to the pump 16 in real time as the centering process proceeds. The shaft encoder 18 will provide pump position versus cell output status to the pump modeling drive as the process continues.

Compensation routines are generally time dependent. Therefore, the fluid output volumes of each of the individual cells 32a, 32b, and 32c will vary with incremental modifications of the motor/pump shaft rotational speed. Accordingly, incremental displacement corrections based on rotational speed of the pump must be included in the compensation routines.

Pump performance variations must also be included in the compensation routines. For example, the amount of “slip” (hydraulic fluid bypass occurring in the pump cells 21a, 21b, 21c) is a result of the pressure differential between the inlet (not shown) and outlet 22 of the pump 20 cells 21a, 21b, 21c. The slip must be compensated for if the volumetric output is to be equal to each centering actuator 26 regardless of the load encountered by each actuator rod 30. Each rod 30 is likely to encounter different loads as the workpiece 1 is inexactly placed on the work surface 54 with regard to the centering actuators 26. In addition to placement of the workpiece 1, the workpiece 1 will experience varying loads as the workpiece 1 moves on the work surface 54. This is known as the stick-slip phenomena and is a result of the workpiece alternately sticking to the work surface 54 and slipping (or sliding) on the work surface 54, with the corresponding change in frictional forces.

Fluid output variations are characteristic of positive displacement pumps as operating conditions change. From the discussion above, flow rate can be affected by the amount of slip occurring in the pump cells 21. As flow rate is a time-based function, in order to insure the fluid output from each cell 21 is equal to every other cell, the delivery time of each cell must be individually modified as a function of pressure, time and shaft rotational speed. This described modification of output from each cell independently provides differential fluid displacement, with regard to each cell, thereby yielding individualized displacement corrections so that actuators 26 advance towards the center point 52 in the same incremental steps regardless of speed or load. Shaft encoder 18 senses the rotational position of the pump shaft and, therefore, the position of each cell in the pump cycle. The drive system 12, in communication with shaft encoder 18, in concert with the calculated pressure feedback developed from profile compensated torque algorithm described in U.S. Pat. No. 6,652,239 to Carstensen, predicts, or feeds forward, the pumping performance of each cell 21 based on known or determined cell characteristics under the instantaneous pump operating parameters. Thus the drive system 12 compensates for pump performance by individually adjusting cell operating parameters to minimize fluid output variations.

In an exemplary centering process, the following steps are used to center a workpiece 1 on the process table work surface 54. The process steps will assume positioning actuators 42 are used, and begin with the support linkage 48 fully rotated in the clockwise direction (fully retracted). At a point to be noted below, the process steps will become independent of the initial positioning used.

As a preliminary operation, profiling of all motions of the centering apparatus is performed to determine the correlation between volumetric pulse output from the pump 16 and actual linear displacement of the centering actuators 26 used. This method of determining the actual displacement of the centering actuators 26 allows feed-forward commands in regard to the acceleration and deceleration rates prior to achieving mechanical end limitation. Thus, the pressure spikes common to this type of process are minimized.

With a workpiece 1 placed on the work surface 54, a user command entered through the user interface 14 signals the drive system 12 to provide a specific hydraulic flow and a pressure limit for flow control valves 38 and isolation valve 39. The hydraulic flow is chosen to provide an acceptable system response. Concurrently, the solenoids for flow control valves 38 and isolation valve 39 are energized to allow hydraulic flow to second hydraulic supply line 34, through directional control valve 41, to pressurize the annulus end of positioning actuator 42, causing the extension of actuator rod 46. Second hydraulic supply line 34 is common, as a manifold, to all positioning actuators 42, thus the positioning actuators 42 are activated concurrently.

The specified flow rate actuates the positioning actuators 42 to rotate the support linkages 48 and centering actuators 26 mounted thereto into centering position as illustrated in section A-A of FIG. 1. Once the support linkages 48 and centering actuators 26 are in position, as may be achieved by abutting a mechanical stop, pump 16 continues to operate until accumulator 56 is fully charged to the user-specified pressure. As discussed above, the pressure should be chosen to secure the support linkage 48 from counter rotation during a centering operation.

At the pressure limit, a force balance is reached in which the requested pressure limit, seen as back pressure to the pump, equals motor torque, which is directly related to pump output pressure. The drive system signals that the prescribed pressure has been reached and the positioning actuators are properly extended, and the motor rotation is signaled to stop. Concurrently, directional control valve 41 is energized and isolation valve 39 is de-energized. Energizing directional control valve 41 isolates the pressurized hydraulic fluid in the positioning actuators and maintains the fluid under the constant pressure of the accumulator. De-energizing isolation valve 39 allows flow of hydraulic fluid to the centering actuators for subsequent steps.

The above recited steps were executed to appropriately position the centering actuators 26 for a centering procedure. The following steps, executed subsequent to positioning of the centering actuators 26, are independent of the process used to position the centering actuators 26 and may be used without the above-recited steps if the centering actuators 26 are otherwise properly positioned.

De-energizing isolation valve 39 places the rod ends 36a, 36b, and 36c of centering actuators 26 in communication with pump cells 21a, 21b, and 21c, respectively. An appropriate user command entered through the user interface 14 establishes a flow and pressure limit to the rod end 36 of centering actuator rod piston 32, forcing all centering actuator rods 30 into a fully retracted initialization position. This step insures that all actuators begin the centering process from the same radial distance from the desired center point 52. When back pressure equals motor torque, which is directly related to pump output pressure, a force balance is reached at the requested pressure limit, the centering actuator rods 30 are their rear most (initialization) position, and the drive system 12 signals the motor 16 to stop rotation. If provided, the position counter is resent at the end of the initialization process to zero for future reference. The centering apparatus is in condition to proceed to the next step in the centering process.

All valves are appropriately energized or de-energized for the centering operation. A command for flow with a pressure limit is entered through the user interface 14. The drive system 12 sends an appropriate control signal to the motor 16 which causes the pump to rotate at the rotational speed necessary for the required flow output. The flow output of the pump has a direct relationship to the motor 16 and pump 20 rotational velocity, which is directly related to the extension rate of the centering actuators 26.

As rotation of the pump occurs, each cell or piston 22a, 22b, and 22c of the pump outputs fluid to the annulus end 28a, 28b, and 28c of centering actuators 26 through first hydraulic supply lines 24a, 24b, and 24c, resulting in linear extension of the centering actuator rods 30a, 30b, and 30c. Motion of the actuator rods 30 is incremental at a known value determined in the actuator profiling step. Further, the extension of the actuator rods 30 is also sequential as each cell 22 displaces one cell volume of hydraulic fluid for each revolution of the pump. In the example illustrated, with three actuators 26, each cell would fire once per revolution, with successive cells firing at 120° intervals of the pump rotation. Each full rotation of the pump shaft will extend each actuator rod 30 the distance determined during profiling. Progressive and sequential incremental extension of the actuator rods 30 will continue until the workpiece 1 is contacted by all of the centering actuators 26a, 26b, and 26c.

Once each of the actuator rods 30 are in contact with the workpiece, additional advancement of any one actuator rod will be resisted by the opposing actuator or actuators. Because the centering actuators 26 are arranged equidistant from a geometric center point 52 and each actuator rod 30 has been extended essentially the same distance, and each rod is in contact with the workpiece 1, workpiece 1 is centered on the work surface 54 to the precision limits of the centering apparatus 10.

The centering process as instantly claimed, therefore, relates to the following general steps:
1) Positioning centering actuators such that they are configured to center a workpiece on a work surface;
2) Initializing each of the centering actuators to a known initialization position;
3) Extending actuator rods from the centering actuators incrementally and sequentially; and
4) Receiving and processing system signals to determine centering process has been completed.

The accuracy of the process is determined by the number of centering actuators 26 used, the volumetric displacement of the cells 21, and the number of incremental extensions of the centering actuator rods 30 per rotation of the pump 20. An increased number of centering actuators 26 provides greater directional control of the workpiece 1 during the centering operation. Smaller volumetric displacements of the cells 21 would correspond to smaller incremental extension of the centering actuator rods 30. Smaller incremental extensions of the actuator rods 30 leads directly to a finer control of the position of the workpiece. Accordingly, the accuracy of the centering process would increase. Similarly, multiples of cells 21 cross-ported to the same centering actuator 26, in a pump of the same displacement, would have a similar result. The number of incremental extensions of actuator rod 30 would double (or triple, etc.) per pump revolution, with a proportionate decrease in size of the increment by half (or one-third, etc.). The smaller incremental moves would lead to smaller centering position tolerance value.

One of ordinary skill in the art would recognize that these process variations may be used individually, in combination with each other, or taken with other process variations not listed, to improve the process accuracy.

Although embodiments of the presently disclosed centering apparatus have been described in detail herein, it is to be understood that this invention is not limited to these precise embodiments and modifications, and that other modifications and variations may be effected by one skilled in the art without departing from the spirit and scope of the invention as defined by the appended claims.

What is claimed is:

1. A centering apparatus comprising:
a plurality of hydraulic centering actuators adapted to center a workpiece on a process table;
a positive displacement hydraulic pump having a plurality of cells;
a motor coupled to the hydraulic pump;
a drive system having a user interface, the drive system linked with the motor; and
wherein each one of the plurality of hydraulic actuators is individually connected to a cell of the hydraulic pump.

2. The centering apparatus according to claim 1 wherein each of the plurality of hydraulic centering actuators comprise:
a rod end;
an annulus end; and
an actuator rod having a free end, the rod configured for linear movement between a retracted position, in which the rod is at least partially retracted into the centering actuator, and an extended position, in which the rod is at least partially extended from the centering actuator.

3. The centering apparatus according to claim 2 wherein each of the plurality of hydraulic centering actuators comprise one or more rollers mounted for rotation to the free end of the actuator rod.

4. The centering apparatus according to claim 1 wherein each of the plurality of hydraulic centering actuators is configured to accept a hydraulic line at the annulus end or rod end.

5. The centering apparatus according to claim 1 wherein the positive displacement hydraulic pump is a piston pump comprising one or more cells.

6. The centering apparatus according to claim 1 wherein the motor is a servo motor, poly-phase induction motor, synchronous motor.

7. The centering apparatus according to claim 6 wherein the motor comprises a shaft encoder.

8. The centering apparatus according to claim 7 wherein the shaft encoder communicates with the drive system.

9. The centering apparatus according to claim 1 wherein the drive system comprises closed loop controls or pump modeling capabilities.

10. The centering apparatus according to claim 1 wherein the centering actuators are supported for rotation with respect to the process table by positioning actuators.

11. The centering apparatus of claim 14 wherein the positioning actuators are adapted to fixedly secure the centering actuators in at least one position.

12. The centering apparatus of claim 11 wherein the positioning actuators are attached to the hydraulic pump.

13. A method of centering a workpiece comprising the steps of:
providing a workpiece;
providing a process table;
providing a centering apparatus comprising:
a plurality of hydraulic centering actuators each comprising an actuator rod having a free end, the rod configured for linear movement between a retracted position, in which the rod is at least partially retracted into the centering actuator, and an extended position, in which the rod is at least partially extended from the centering actuator.
a positive displacement hydraulic pump having a plurality of cells;
a motor coupled to the hydraulic pump;
a drive system having a user interface, the drive system linked with the motor;
wherein each one of the plurality of centering actuators is individually connected to a cell of the hydraulic pump;
securing the centering actuators proximate to the workpiece;
commanding the drive unit to rotate the pump at a first specified rotational speed to supply a first specified flow to the hydraulic actuators;
initializing the position of centering actuators using the first specified flow;
commanding the drive unit to rotate the pump at a second specified rotational speed to supply a second specified flow to the centering actuators;
advancing the centering actuator rods in known increments and sequentially to engage the workpiece using the second specified flow until all actuator rods are in contact with the workpiece; and
signaling the control unit to cease rotation of the pump at such time that a predetermined pump output pressure is achieved, indicating the workpiece is centered on the process table within an acceptable tolerance.

14. The method of claim 13 further comprising:
providing positioning actuators secured to
commanding the drive unit to rotate the pump at a specified positioning rotational speed to supply a specified positioning flow to positioning actuators;

15. A method for maintaining uniform displacement of a hydraulic actuator in a hydraulic system, the method comprising the steps of:
providing a positive displacement pump having a shaft and a plurality of cells;
sensing the output pressure of one of the plurality of pump cells;
sensing the inlet pressure of the pump cell;
sensing the pump shaft rotational speed;
providing a compensation routine to determine a hydraulic slip of the pump cell as a function of the cell output pressure, the cell inlet pressure, and the pump shaft rotational speed;
compensating for the hydraulic slip of the cell by modifying delivery time of the cell; and
delivering a uniform volume of hydraulic fluid from the pump cell to the actuator.
